(19) United States
(12) Patent Application Publication
(10) Pub. No.: US 2002/0137547 A1
(43) Pub. Date: Sep. 26, 2002

(54) Antenna array and method therefor

(76) Inventor: Bruce A. Judson, San Luis Obispo, CA (US)

Correspondence Address: Qualcomm Incorporated, Patents Department, 5775 Morehouse Drive, San Diego, CA, 92121-1714, US

(21) Appl. No.: 09/778,284

(22) Filed: Feb. 7, 2001

(51) Int. Cl. H04B 1/06; H04M 1/00; H01Q 21/20

(52) U.S. Cl. 455/562; 455/272; 343/799; 343/850

(57) ABSTRACT

An antenna apparatus (200) including a forward link antenna array (212, 214, 216, 218) and a reverse link antenna array (210, 214, 220, 222) coupled by a plurality of circulators (224, 226, 228). The circulators direct the signals for the forward link and reverse link to and from the appropriate antenna elements in the appropriate direction. The forward link and reverse link antenna arrays use a common set of coaxial cables (230) to communicate with the base station circuitry.

### BACKGROUND

1. Field

The present invention pertains generally to communications, and more specifically to an antenna array and method therefor in a wireless communications system.

2. Background

Wireless communications systems employ antennas to transmit and receive signals via an air interface. Antenna arrays referred to as “smart antennas” synthesize antenna patterns using multiple antennas to form beams. Smart antennas are intended to optimize performance utilizing the spatial aspects of the radio frequency channel within a communications system.

While it is possible to use a same antenna or antenna array for transmission and reception, each has specific design criteria. For transmission, antennas are best located in close proximity, but for reception, a large separation between antennas is desirable. There is a need, therefore, for an antenna configuration that optimizes transmission and reception. Further, there is a need for an antenna array that increases the capacity and efficiency of communication systems.

### SUMMARY

According to one aspect, an antenna apparatus is operative in a wireless data communication system having a first antenna element, a second antenna element, and a circulator coupled to the first and second antenna elements, wherein the circulator directs signals to the first antenna and receives signals from the second antenna.

### BRIEF DESCRIPTION OF THE DRAWINGS

FIG. 1 is a diagram for a communication system configured according to one embodiment.

FIG. 2 is a diagram for a cell having three sectors in a communication system as in FIG. 1 according to one embodiment.

FIG. 3 is a diagram for an antenna array according to one embodiment.

FIG. 4 is a diagram for an antenna coverage pattern according to one embodiment.

FIG. 5 is a diagram for a directed beam coverage of an antenna array according to one embodiment.

FIG. 6 is a diagram for a base station configured according to one embodiment.

FIG. 7 is a diagram for a cell site modem and associated antenna configured according to one embodiment.

FIG. 8 is a diagram for a base station configured according to one embodiment.

FIG. 9 is a diagram for a cell with associated antenna array configured according to one embodiment.

FIG. 10 is a diagram for an antenna array configuration according to one embodiment.

FIG. 11 is a diagram for a circulator according to one embodiment.

### DETAILED DESCRIPTION

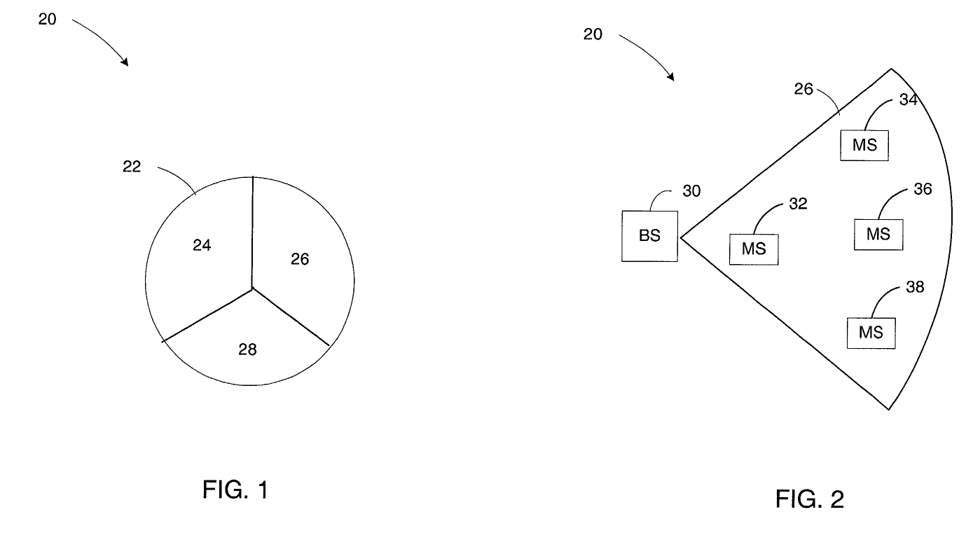

A wireless communication system, such as system 20 illustrated in FIGS. 1 and 2, includes a plurality of geographical coverage areas referred to as cells. Each cell is serviced by a Base Station, or BS, that communicates with users, or Mobile Stations, or MSs, within the cell. A cell may be divided into multiple sectors, wherein a typical division may result in three or six sectors per cell. A cell division according to one embodiment is illustrated in FIG. 1, The cell 22 includes sectors 24, 26, 28. The size and dimensions of each sector 24, 26, 28 are illustrated as approximately uniform. However, cell 22 may be divided any number of ways. Each sector 24, 26, 28 has a corresponding directional antenna, multiple antennas, or a group of directional antennas referred to as an antenna array (not shown). A directional antenna allows adjustment of transmission and reception directions to accommodate the system configuration and environment. The directional antenna coverage area defines the shape of the sector.

As illustrated in FIG. 2, sector 26 of system 20 is serviced by BS 30. At any given time any number of users may be located within sector 26. As illustrated, MSs 32, 34, 36, 38 communicate with BS 30 as they move within sector 26. In one embodiment, the system 20 is a Code Division Multiple Access, CDMA, system such as specified in the “TIA/EIA/IS-2000 Standards for cdma2000 Spread Spectrum Systems” referred to as “the cdma2000 standard.” Alternate embodiments may include other spread-spectrum systems, such as specified in “TIA/EIA/IS-95 Mobile Station-Base Station Compatability Standard for Dual-Mode Wideband Spread Spectrum Cellular System” referred to as “the IS95 standard,” Frequency Division Multiplexing, FDM, systems, such as Groupe Speciale Mobile, GSM, Time Division Multiplexing, TDM, systems, etc.

Communications between the BS 30 and the MS 32, 34, 36, 38 are sent over a radio air interface. Transmissions originating from the BS 30 are referred to as Forward Link, FL, transmissions, and transmissions originating from the MS are referred to as Reverse Link, RL, transmissions. The FL and RL are separated in frequency, wherein FL transmissions are sent at a first frequency and RL transmissions are sent at a separate frequency. Frequency separation of the FL and RL is referred to as Frequency Division Duplex, FDD, wherein the FL and RL transmissions are duplexed through a single transceiver. An advantage of frequency separation, and FDD, is the concurrent transmission and reception using a single antenna or common antenna array. Alternate embodiments may implement a Time Division Duplex, TDD, scheme, wherein each radio frequency channel is divided into multiple time slots.

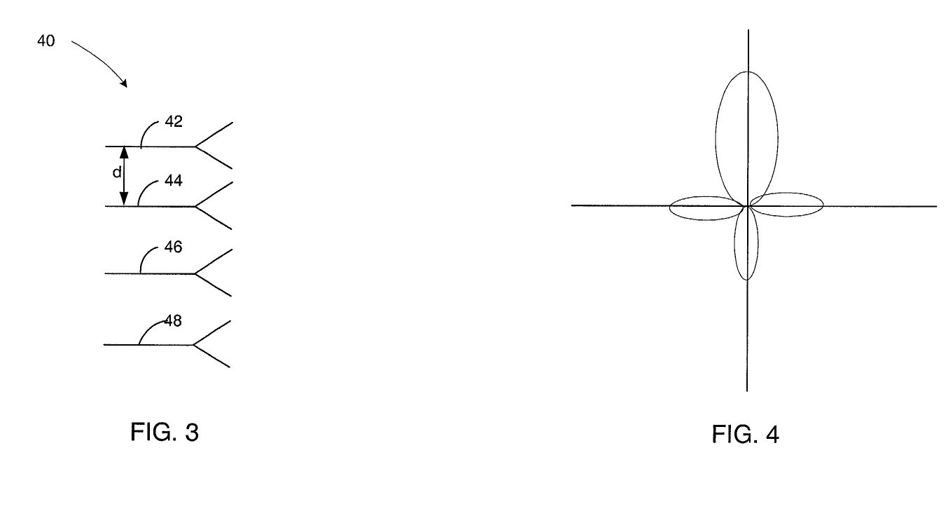

In one embodiment, BS 30 transmits signals within sector 26 using an antenna array 40 illustrated in FIG. 3. Antenna array 40 includes antenna elements 42, 44, 46, 48, each separated by a distance d. Generally, radio antennas couple electromagnetic energy from one medium to another. In a communication system, antennas are used to transmit and receive electromagnetic energy via the radio air interface. For reception, antenna arrays are designed with a predetermined spacing between antenna elements. In a cellular radio frequency environment, a receiver experiences fading, wherein multiple versions of the transmit signal randomly add together. When these signals add destructively, e.g., out-of-phase combinations, the signals cancel each other, thus creating a fade in the received signal. Diversity is a term used to describe a method of using multiple receive antennas, wherein the received signals are combined to form a single received signal. If the envelope of each received signal is un-correlated, the probability of all received signals fading at the same moment in time is less than the probability of any single received signal fading at a given moment. The resultant combination, therefore, has a more uniform envelope. The correlation of the signal envelope is referred to as the diversity. In this way, a low correlation corresponds to a high diversity and a high correlation corresponds to a low diversity. Diversity basically combines multiple replicas of a transmitted signal. The combination of redundant information received over multiple fading channel tends to increase the overall received Signal-to-Noise Ratio (SNR).

Consider also that each user in a wireless system has a uniquely associated spatial channel. The base station can perform spatially selective transmission/reception in an efficient manner by exploiting this characteristic.

Antenna diversity improves reception by reducing the effects of multipath fading, such as Raleigh fading, experienced at a receiver. Fading occurs when received signals include reflections of the originally transmitted signal. Reflections are introduced as multi-paths, or indirect signal paths, reflect off of objects within the system environment. In practice, there are many reflected signal paths from many different directions. The multi-paths combine constructively and destructively at the receiver. The resultant wave pattern received has areas of fade, i.e., low amplitude signals. Multipath fading is due to the construction and destructive combination of randomly delayed, reflected, scattered and defracted signal components. Multipath fading is relatively fast and introduces short-term variations to the transmitted signals. Fast fading indicates that the fading decorrelates from symbol to symbol of a transmission. Raleigh fading specifically refers to a model wherein there is no direct LOS path. The channel fading amplitude is Raleigh distributed and thus the name.

As an MS moves throughout the system, successive drops of amplitude, or fades, occur. Therefore, it is possible to design fade-independent antenna elements by spacing antenna elements appropriately. In this way, when one antenna element experiences a fade, at least one of the other antenna elements in the array will be outside of the fade. For optimized reception, the distance d between antenna elements 42, 44, 46, 48 of antenna array 40 of FIG. 3 is approximately five wavelengths of the transmitted signal.

In one embodiment, a rake receiver exploits the multipath signals received by the multiple antenna elements of an antenna array. Rake receivers process the individual multipath signals and combine them to form a composite signal. Rake receivers may exploit both the spatial and temporal diversities of a wireless system. The temporal diversities arise as the signal is altered by the air interface over time. The rake receiver is a coherent combiner of multipath signals. Rake receivers operate in the temporal domain.

CDMA systems are spread-spectrum systems that spread transmitted signals over a large frequency band and transmit the signals with low power per unit bandwidth. In a CDMA system the capacity of a given cell depends on several factors including receiver demodulation, power-control accuracy, and actual interference power introduced by other users in the same cell and neighboring cells. One link metric having a correspondence with cell capacity is E_{b}/Nₒ, or energy per bit per noise power density. The energy per bit, E_{b}, is calculated as the average modulating signal power multiplied by the time duration of a bit. The noise power density, Nₒ, is the total noise power divided by the bandwidth. Another metric that may more accurately reflect conditions in the environment is the total interference power density, I₀, which represents both thermal noise and interference power from other sources, i.e., other transmissions. The SNR of a single user is considered as (1/(M−1)), with respect to the total users in the cell designated as M. The total interference power is equal to the sum of the powers from individual users. Therefore, each of the users experiences approximately the same (1/(M−1)) SNR. The number of users is inversely proportional to the individual SNR. In other words, as M increases the SNR is reduced. The E_{b}/I₀ is equal to the SNR multiplied by the bandwidth divided by the bit rate, and therefore serves as an indicator of the capacity of the cell. Power control keeps the E_{b}/I₀ or SNR constant.

The return link in a CDMA system has two Power Control, PC, loops: an inner loop; and an outer loop. The inner loop operates relatively quickly to maintain E_{b}/I₀ constant at a predetermined level. The outer loop operates more slowly seeking to keep the Frame Error Rate, FER, constant at a predetermined level. In a mild fading environment, the outer loop will increase the required E_{b}/I₀, inner loop set point, to maintain the required FER, e.g., 4 dB E_{b}/I₀ for a 1% FER. A reduced E_{b}/I₀ equates to a reduced signal interference, and therefore more capacity. The role of diversity is to create a “mild” signal in a harsh fading environment.

For transmission, the Carrier-to-Noise ratio (C/N) is a convenient metric for the quality of the channel. The C/N is calculated as a function of the Effective Radiated Power (ERP) of the transmit antenna(s). The ERP is a function of power at the output of the transmit power amplifier, cable loss between the power amplifier and the transmit antenna(s), and the gain of the transmit antenna. An alternate metric is Carrier-to-Interference (C/I) which considers not only noise but interference from other users. Still another metric for the FL is E_{b}/I₀, or the energy per chip per interference density measured on the pilot channel.

Ideally, the transmit antenna(s) creates a beam to a single user. The single beam may then be of reduced power. Antenna design techniques referred to as smart antennas synthesize the beams intending to provide individual beams to individual users, thus reducing the transmit power of the system. Smart antenna systems seek to mitigate the interference generated with respect to other users in the cell.

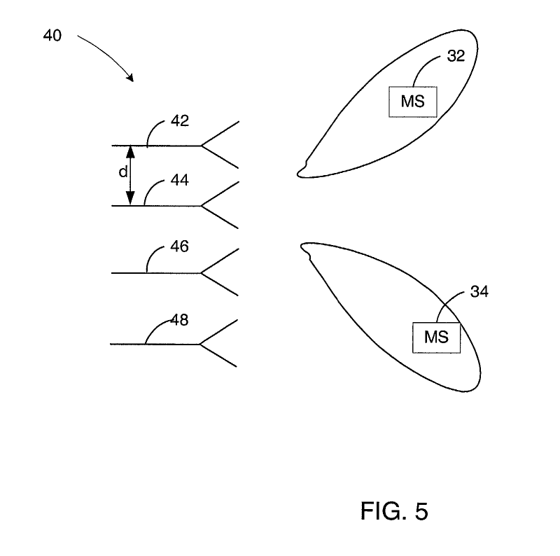

While diversity of antenna elements improves reception, receiver diversity desires antennas spaced far apart. In contrast, transmitter beamforming desires antennas spaced close together. Multiple antennas allow the base station, or transmitter, to create individual coverage areas for each targeted recipient, with the requirement that antenna elements of an antenna array be placed in close proximity. FIG. 4 illustrates an antenna coverage pattern for a four element antenna array, such as antenna array 40 of FIG. 3. The antenna generating the coverage pattern of FIG. 4 is a sectorized antenna. Sectorized antenna systems subdivide a cellular area into sectors that are covered by directional antennas from a common base station location. Operationally, each sector is treated as a different cell, the range of which is greater than using an omnidirectional antenna. Combinations of directional antennas provide increased coverage of a geographical area.

A smart antenna system may automatically change the directionality of its radiation pattern in response to its signal environment. The result may be an increase in the performance characteristics of a wireless system, including but not limited to coverage and capacity. Smart antenna systems may be switched beam or adaptive array systems. The switched beam type system has a finite number of fixed, predefined patterns or combined strategies, i.e., sectors. The adaptive array type has an infinite number of scenario-based patterns that are adjusted in real time. The smart antenna systems combine an antenna array with a digital signal processing capability to transmit and receive in an adaptive, spatially sensitive manner.

With respect to FIG. 4, the antenna coverage pattern is illustrated, wherein antenna gain is plotted as a function of azimuth angle. The illustrated pattern has four lobes, one corresponding to each antenna element. The pattern is defined by an energy threshold, wherein the energy at locations outside the lobe is less than a predetermined energy threshold level. The energy generated in the coverage area defined by the pattern is referred to as the antenna beam. As illustrated, the antenna is adjusted for transmission in the direction of the largest lobe. The other lobes are directed to other areas not intended for the transmission.

It is desirable to reduce the size of the lobes to non-intended transmission areas so as to reduce the interference in these areas. In practice, when the antenna elements are close together it is possible to create coverage patterns with directed lobes. However, as the distance between antenna elements increases the coverage pattern approaches a single lobe or circle, similar to a coverage pattern generated by an omnidirectional antenna. For spacing greater than 5 wavelengths there is low correlation between different transmission signals. Therefore, it is desirable for transmission antenna arrays to have a close spacing between antenna elements.

The proximity of the antenna elements is directly related to the control of forming the distinct beams. The antenna spacing, therefore, determines the distinct features of the created lobes or beams. The individual beams are referred to as directed coverage areas. The directed coverage areas reduce interference experienced per user and the energy required for transmissions, which in turn increases the capacity of the system. Less energy is required per user as each user's transmission is generated in only a small area. Specifically, a beam is generated in the general area of the target recipient(s). Multiple distinct beams may be generated. This eliminates the need to transmit each user's transmission throughout the entire sector and/or cell.

FIG. 5 illustrates an instance of directed antenna beams to MS 32 and MS 34 of sector 26 of FIG. 2. The signals for MS 32 and MS 34 are superimposed on the transmission of antenna array 40 resulting in the coverage patterns illustrated. For sinusoidal transmissions, the individual transmissions are additive. The antenna array 40 concurrently transmits signals to the two lobes. Alternate instances may direct the transmissions from antenna array 40 to any number of MS within sector 26.

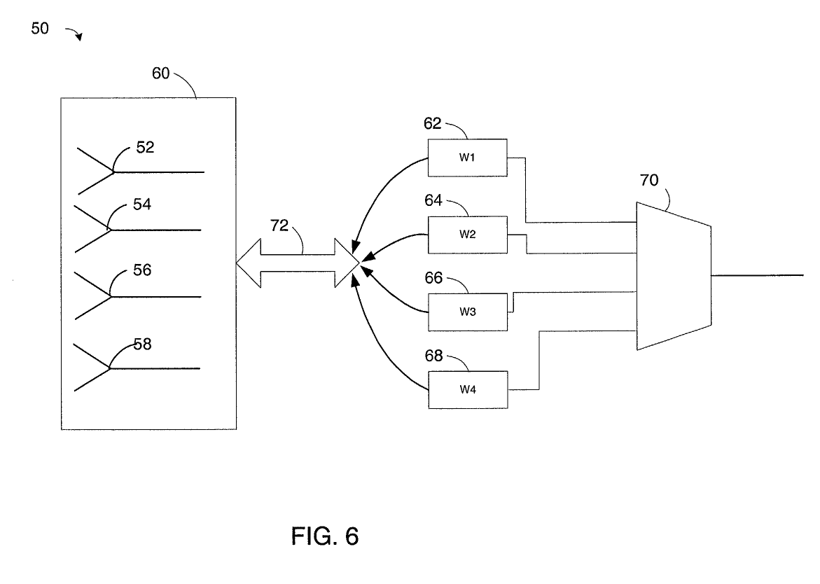

In one embodiment, the directed antenna beams are generated by a BS 50 as illustrated in FIG. 6. The BS 50 includes an antenna array 60 having four antenna elements 52, 54, 56, 58 coupled to multiple weighting units 62, 64, 66, 68 by way of conductor 72. In one embodiment, conductor 72 is a set of coaxial cables, referred to as heliax cable. Each of the weighting units 62, 64, 66, 68 corresponds to an antenna element 52, 54, 56, 58, respectively. Alternate sets of weighting units are provided on a per user basis. The weighting units 62, 64, 66, 68 apply the appropriate weighting factor to each signal to form the desired antenna beams from antenna array 60. The weighting factor adjusts the phase and amplitude of the signal to be transmitted.

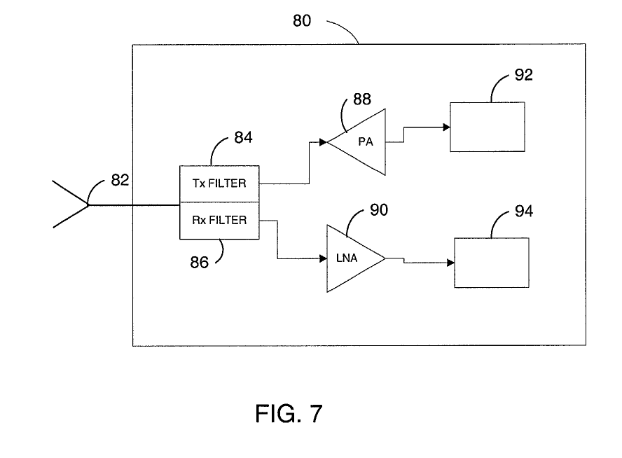

FIG. 7 details a transceiver duplexor 80 similar to duplexor 70 according to one embodiment. Duplexor 80 includes a transmission path and a receiver path. The transmission path includes a Tx filter 84 coupled to a Power Amplifier (PA) 88 and transmit circuitry 92. The signal to be transmitted is processed by transmit circuitry 92, wherein the signal is encoded and modulated. The processed signal is then provided to the PA 88 for amplification for transmission. The amplified signal is then filtered by Tx filter 84 and provided to antenna 82. For a system using multiple transmit antennas, the signal provided to the antenna 82 is weighted by adjusting the phase and amplitude with respect to the antenna array. The receiver path includes an Rx filter 86 coupled to a Low Noise Amplifier (LNA) 90 and receive circuitry 94. The signal received via antenna 82 is initially filtered by the Rx filter 86. The filtered signal is then provided to LNA 90 which amplifies and provides an output to receive circuitry 94 that extracts the baseband signal for further processing. The receive circuitry 94 may include the radio front end, which includes the duplexor 80. The LNA 90 provides reception improvement, wherein the LNA 90 has a gain G and a noise figure F. The LNA 90 reduces the noise figure of the receiving system of the BS 50. The loss L affects the Signal-to-Noise Ratio (SNR) of the signal as output from the receive circuitry 94.

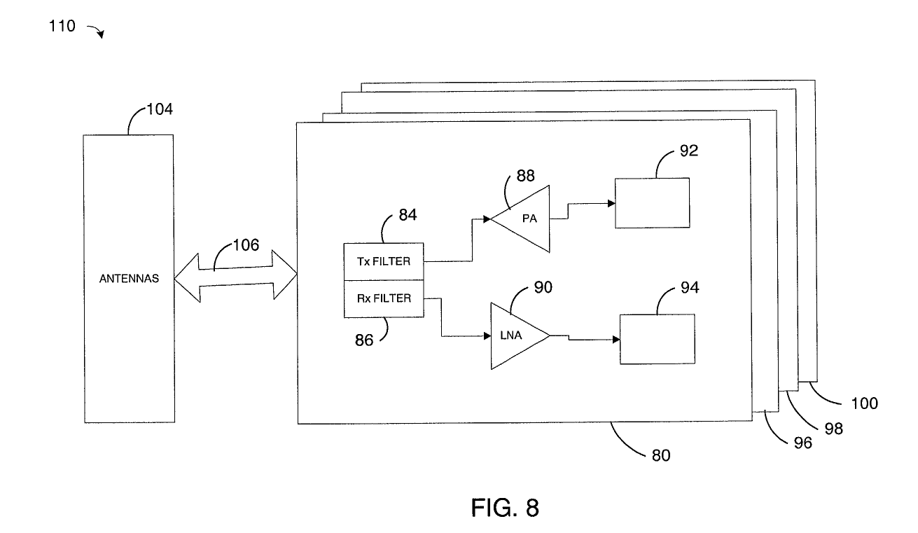

FIG. 8 illustrates a BS 110 according to one embodiment having antenna array 104 coupled to multiple duplexors 80, 96, 98, 100. Each duplexor is similar to duplexor 80 having both a transmission path and a reception path. Each of the duplexors 80, 96, 98, 100 is coupled to an antenna element within antennas 104. The connection is made by way of coaxial cables configured to form a heliax cable. Typically, the duplexors are located in the base station sitting on the ground of a cell site. The heliax cable runs from the duplexors up the length of the antenna tower to couple with each antenna element of the antennas 104. The length is typically several feet, and the size of the heliax cable is very large. This type of hardware configuration is placed when the antenna tower and base station are placed. It is difficult and costly to change or replace the heliax cable and its connectors to the base station.

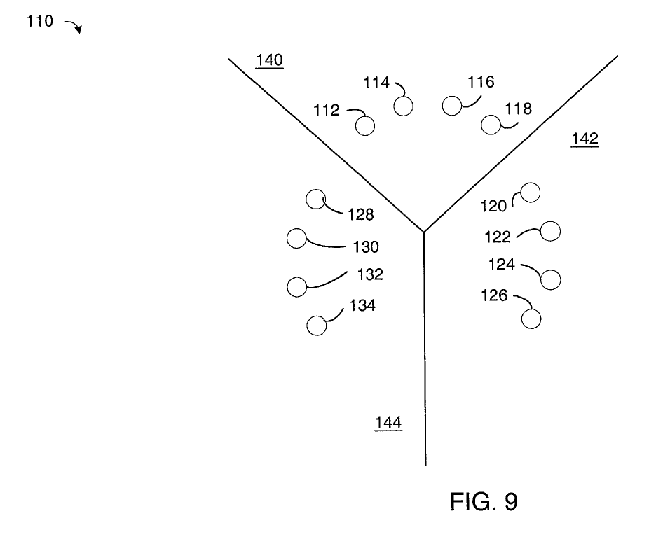

FIG. 9 illustrates one embodiment of a sectorized cellular communication system 110 having a cell divided into three sectors 140, 142, 144. Antenna elements are located within each sector 140, 142, 144. Each antenna array includes four antennas. Sector 140 has antenna elements 112, 114, 116, 118. Sector 142 has antenna elements 120, 122, 124, 126. Sector 144 has antenna elements 128, 130, 132, 134. The antenna elements in each sector are configured in an arc shape. The spacing between the antenna elements within a sector is close, sufficient for transmission. In one embodiment, the spacing between antenna elements is one quarter wavelength. The spacing provides improved transmission and increases the capacity of the system. For transmission within a given sector, all four antenna elements are used to transmit signals. In other words, the FL uses all antenna elements. While the four antennas of a sector may be used for reception, i.e., the RL, the antenna spacing provides little to no improvement in reception. The spacing of the antenna elements within a sector is too close for improved reception.

One embodiment uses two antennas for the RL, one from each of two sectors, wherein the spacing between the two antennas is approximately five wavelengths, which is sufficient to improve reception. According to this embodiment, reception of signals from within sector 140 may utilize antenna element 118 from sector 140 with antenna element 120 from sector 142. Alternately, reception within sector 140 may utilize antenna element 112 from sector 140 and antenna element 128 from sector 144. Similarly, reception within sector 142 may utilize antenna elements 118 and 120, or antenna elements 126 and 134. Also, reception within sector 144 may utilize antenna elements 126 and 134, or antenna elements 112 and 128. Alternate embodiments may employ any number of antenna elements that meet a predetermined distance criteria between each antenna element. One drawback of these configurations is the need to run four coaxial cables per sector for a total of twelve coaxial cables. The addition of antennas to improve RL antenna diversity will require the addition of coaxial cables to the system. This increases the complexity and size of the antenna tower and base station.

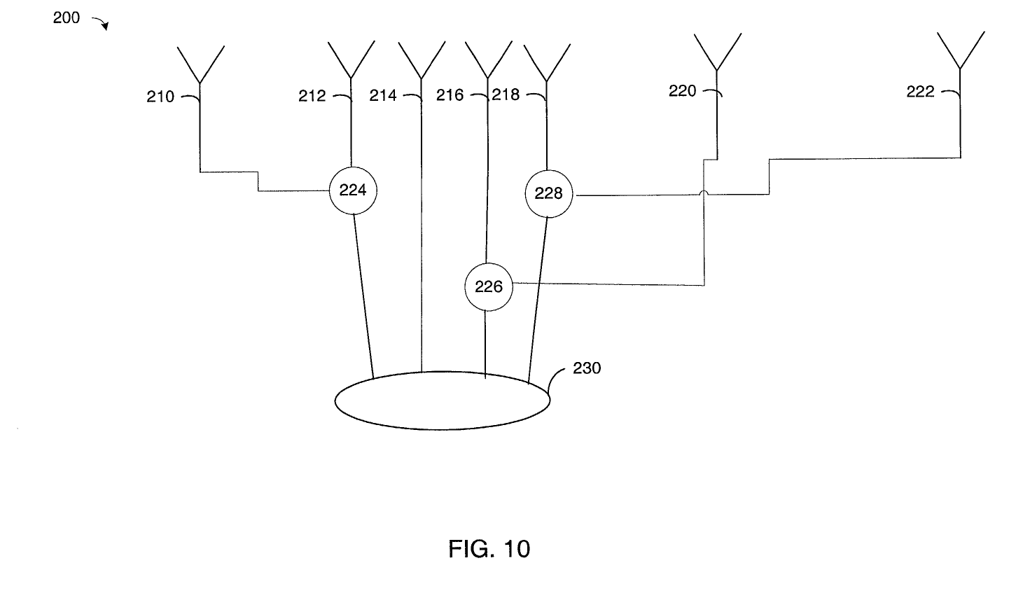

The size of the heliax cable and antenna tower, is reduced in one embodiment illustrated in FIG. 10. The BS 200 serves a sectorized, wherein circuitry for serving one sector is illustrated. The BS 200 includes seven antenna elements 210, 212, 214, 216, 218, 220. Antenna elements 210 and 212 are coupled to a circulator 224 (illustrated in FIG. 12). Antenna elements 216 and 220 are coupled to a circulator 226. Antenna elements 218 and 222 are coupled to a circulator 228. The circulators 224, 226, 228 are magnetic elements having directional connections. FIG. 12 illustrates circulator 224 having three connectors labeled A, B, and C. Each connector is an Input/Output (I/O) port. The circulator 224 provides a unidirectional path for each connector pair. For the connector pair A, B, a first unidirectional path is formed from B to A, as illustrated. Energy received as input at connector B is transferred as output at connector A. This path 232 is illustrated by a directional arrow from connector B to connector A. In a similar manner, energy inputs to connector A are transferred as outputs to connector C, and inputs from connector C are transferred as outputs to connector B. In this way, the circulator 224 circulates inputs at each of the connectors to another connector according to a predefined relationship. In one embodiment, circulator 224 is a magnetic device, wherein the relationships between connector pairs may be adjusted by providing a current to a control port (not shown) of the circulator 224. Alternate embodiments may implement alternate connection devices having similar unidirectional paths formed per connector pair.

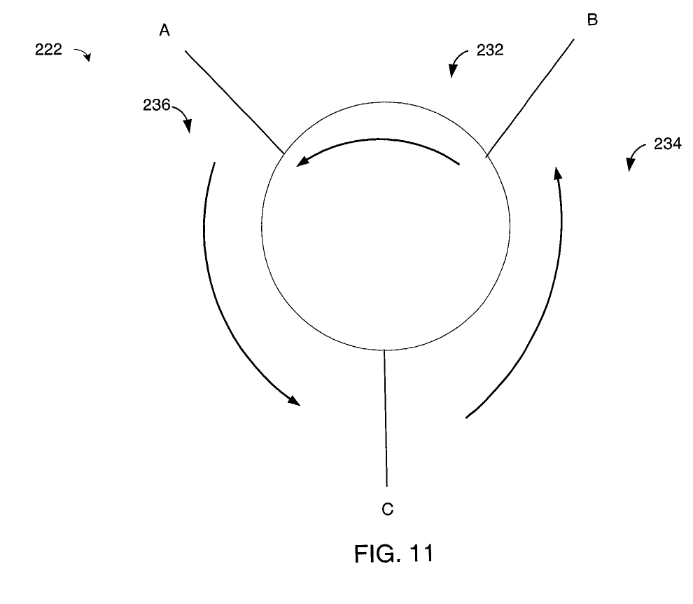

Returning to FIG. 11, the FL utilizes antenna elements 212, 214, 216, 218, which are placed in close proximity, such as with one quarter wavelength spacing. Signals are received at connector 224, from the base station and routed to transmit antenna 212. Similarly, signals are transmitted to circulators 226, 228 and routed to antenna elements to 216, 218, respectively. Note that signals are transmitted to antenna element 214 directly as is discussed hereinbelow. The antenna elements 212, 214, 216, 218 form a directed antenna array that is used to generate the individual beams for users within the sector. Note any combination of antenna elements 212, 214, 216, 218 may be used to generate the desired patterns. The antenna elements 212, 214, 216, 218 are coupled to the base station circuitry by way of four coaxial cables. The heliax cables run from the antenna elements at the of the antenna tower (not shown) to the base station at the bottom.

The antenna elements 210, 214, 220, 222 are used for RL transmissions, and each pair of neighboring antenna elements are spaced approximately five wavelengths apart. The circulators 224, 226, 228 allow the existing coaxial cables within the heliax cable 230 to be re-used for RL reception. In this way, signals received at element 210 are transferred through circulator 224 to the base station using a same coaxial cable as for transmissions for antenna element 212. Similarly, the coaxial cables for antenna elements 214, 216, 218 are re-used for RL receptions from antenna elements 214, 220, 222, respectively. With respect to FIG. 10, the RL antenna elements 210, 220, 222 are coupled to the A input, the FL antenna elements 212, 216, 218 are coupled to the B output, and the coaxial cables are coupled to the C port of circulators 224, 226, 228, respectively. In the system 200 illustrated in FIG. 10, antenna element 214 is not coupled to a circulator. Alternate embodiments may couple antenna element 214 to a circulator coupled to another RL antenna element. In still other embodiments, a different number of antenna elements may be used for the RL, such as two antenna elements. The addition of RL antenna elements improves antenna diversity and thus reception quality. However, the addition of RL antenna elements incurs the cost of the antenna element as well as the need to place the RL antenna elements at a predetermined distance from each neighboring RL antenna element. Therefore, the number of RL antenna elements used and the configuration applied is specific to the communication system to which it applies as well as the environment and geographical layout of such communication system.

The system 200 illustrated in FIG. 10 allows addition of the antenna elements 210, 220, 222 to an existing system, such as system 110 of FIG. 9, without the need for additional coaxial cables through heliax cable 230. The antenna elements may be added consistent with a predetermined distance between neighboring antenna elements desirable for reducing multi-path fading and other transmission effects associated with RL transmissions. Note that alternate embodiments may configure the FL and/or RL antenna elements in a shape similar to that of system 110 of FIG. 9 or according to an alternate scheme to maximize the efficiency of the communication system.

Alternate embodiments may employ alternate communication system schemes, such as High Data Rate (HDR) systems. In particular, alternate embodiments may include any system having differing RL and FL antenna design criteria independent of modulation scheme.

In one embodiment, the antenna configuration as in FIG. 11 is applicable to a mobile station, wherein FL signals are received at the mobile station and RL are transmitted from the mobile station. The difference in antenna spacing between receive antennas and transmit antennas tends to be more pronounced at the base station. In wireless systems this is due to the different characteristics of received signals at the base station compared to the mobile station. Specifically, the spacing of the antennas sufficient to receive uncorrelated signals is a function of the angle of arrival of in coming signals. When the angular spread of incoming signals is narrow, the antennas are to be spaced farther apart. This is typically the case for RL signals received at the base station. In contrast, the mobile station typically has a wide angular spread for FL signals. Therefore, the mobile station often affords closer spacing of the receive antennas.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An antenna apparatus in a wireless data communication system, comprising:
a first antenna element;
a second antenna element; and
a circulator coupled to the first and second antenna elements, wherein the circulator is configured to transmit signals to the first antenna and receives signals from the second antenna.

2. The antenna apparatus of claim 1, wherein the first antenna element is operative for forward link transmissions and the second antenna element is for reverse link transmissions.

3. The antenna apparatus of claim 1, wherein the circulator is coupled to a coaxial cable, wherein signals to the first antenna and signals from the second antenna are processed via the coaxial cable.

4. The antenna apparatus of claim 1, wherein the apparatus is operative within a first sector of a cellular communication system.

5. The antenna apparatus of claim 1, wherein the first antenna element is part of a directional antenna array.

6. The apparatus of claim 5, further comprising:
a third antenna element separated from the second antenna element by a first distance.

7. In a wireless communication system capable of data communications, a base station comprising:
a first coaxial cable operative at one end to couple to a first forward link antenna element and a first reverse link antenna element, the first coaxial cable operative at another end to couple to a base station,
wherein the first forward link antenna element is a different antenna element than the first reverse link antenna element.

8. The cable of claim 7, wherein the first coaxial cable is part of an antenna tower.

9. The cable of claim 7, wherein the first coaxial cable is coupled to a circulator operative to control a forward link and reverse link transmissions.

10. The cable of claim 7, further comprising:
a second coaxial cable operative at one end to couple to a second forward link antenna element and a second reverse link antenna element, the second coaxial cable operative at another end to couple to a base station;
wherein the second forward link antenna element is a different antenna element than the second reverse link antenna element.
